(19) United States
(12) Patent Application Publication
(10) Pub. No.: US 2006/0240812 A1
(43) Pub. Date: Oct. 26, 2006

(54) Network support for suspect's geo-location monitoring and alerting

(76) Inventors: David S. Benco, Winfield, IL (US); Sanjeev Mahajan, Naperville, IL (US); Baoling S. Sheen, Naperville, IL (US); Sandra L. True, St. Charles, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/113,785

(22) Filed: Apr. 25, 2005

(51) Int. Cl. H04Q 7/20

(52) U.S. Cl. 455/421

(57) ABSTRACT

An apparatus in one example has: at least one high security area in the wireless telecommunications network; a storage in the wireless telecommunications network, the storage having at least one phone number corresponding to the at least one mobile terminal; detection module in the wireless telecommunications network that outputs a signal when at least one mobile terminal, corresponding to the stored phone number, enters the at least one high security area, the detection module operatively coupled to the storage; and notification module in the wireless telecommunications network that outputs a notification message when the at least one of the mobile terminal enters the at least one high security area, the notification module operatively coupled to the detection module.

### TECHNICAL FIELD

The invention relates generally to telecommunication networks, and more particularly to a telecommunication network that provides a monitoring system to monitor the geo-locations of identified suspects.

### BACKGROUND

Government or law enforcement agents are always monitoring phone calls for some pre-defined group of suspects in their list. They will be informed only if any of the monitored persons originate or terminate a call. However, for many other situations the law enforcement agents should be informed when these persons approach or enter a high security area. For example, the law enforcement agents should be informed when an identified potential terrorist enters a federal government or state building or even an airport. Thus, special attention can be paid to prevent any potential terrorist attack.

Cellular telephone communications technologies have advanced rapidly in the last decade. One development of cellular telephone communications is the advent of digital microcells. Such systems use of a plurality of contiguous cells, each cell with a master site and a plurality of zone sites defining communication zones, which are defined by a plurality of suitably positioned antenna sets within the periphery of the cell. Consequently, each zone has a transmitting and receiving means directionally configured to limit propagation of signals substantially to a zone within the boundaries of the cell.

Microcell network architecture typically covers “deadspots” or high traffic density areas occurring in larger macrocells. For example, one cell structure that may be suitable for high traffic personal communication networks includes a plurality of macrocells. A plurality of microcells is selectively deployed within a macrocell in areas of very high traffic density. The microcell architecture allows an increase in caller handling capacity. A typical macrocell may be 1 km or more in radius. A typical microcell may cover an area of approximately 200 m radius, for example, with each microcell typically having a capacity of handling 8 to 16 callers.

In a typical analog cellular telephone system, a plurality of contiguous cells, each having a different assigned set of transmission frequencies, are arranged with handoff means for maintaining continuous communication with mobile telephones moving from cell to cell. As a mobile unit travels along a path that passes from one cell to another, a handoff occurs which switches the mobile unit from a frequency in the set assigned to the cell it is leaving, to a new frequency in the set assigned to the cell it is entering. The handoff action is controlled by a mobile switching center (MSC), which receives a handoff command or instruction. The handoff command is typically generated when the signal received from the mobile telephone falls below a pre-selected signal strength thus indicating that the mobile telephone is at the cell boundary.

In an analog system, each cell in a cellular telephone system operates with a different assigned set of transmission frequencies. As a mobile telephone passes from one cell to another, the handoff signal instructs the cell which the mobile telephone is entering to begin transmitting at a frequency which is different from the frequency which was being transmitted by the cell which the mobile telephone was leaving. A similar procedure is followed when the mobile telephone passes into the next contiguous cell. Sets of assigned frequencies are different for adjacent cells, and such sets are not repeated except for cells that are far enough away from each other so that interference problems will not occur. In the case of systems using identification codes, the identification codes are generally not repeated.

A mobile telephone unit (mobile terminal) typically contains a control unit, a transceiver, and an antenna system. Each cell site typically is provided with a control unit, radio, a power plant, data terminals, and antennas. The MTSO provides coordination for all the cell sites and contains suitable processing and switching means. The MTSO also interfaces with the telephone company zone offices for standard hardwired telephone systems. The communication links between the MTSO and the various cell sites are typically microwave, T carriers, or optical fiber, and carry both voice and control data between the cell sites and the MTSO.

Even in view of the advances in the art of cellular telecommunications, there is still a drawback in the prior art regarding security for buildings and other areas and the monitoring of identified suspects.

### SUMMARY

The invention in one implementation encompasses an apparatus. The apparatus may comprise at least one mobile terminal in a wireless telecommunications network; at least one high security area in the wireless telecommunications network; a storage in the wireless telecommunications network, the storage having at least one phone number corresponding to the at least one mobile terminal; detection module in the wireless telecommunications network that outputs a signal when at least one mobile terminal, corresponding to the stored phone number, enters the at least one high security area, the detection module operatively coupled to the storage; and notification module in the wireless telecommunications network that outputs a notification message when the at least one of the mobile terminal enters the at least one high security area, the notification module operatively coupled to the detection module.

The invention in another implementation encompasses a method. This method may comprise: implementing a trigger using obtained mobile geo-location information to determine if a mobile terminal is entering a predetermined high security area; and sending a notification message if the trigger outputs a signal that the mobile terminal has entered the predetermined high security area.

Another implementation of the invention encompasses a method. This method may comprise: provisioning a list of high security areas and associated geo-locations; provisioning a list of phone numbers, respectively corresponding to mobile terminals, for notification when at least one of mobile terminal enters one of the high security areas; and sending a notification message when at least one of mobile terminal enters one of the high security areas.

### DESCRIPTION OF THE DRAWINGS

Features of exemplary implementations of the invention will become apparent from the description, the claims, and the accompanying drawings in which:

FIG. 1 is a representation of one implementation of an apparatus that provides for monitoring the geo-locations of any suspicious people based on their phone numbers and geo-location security features for a predetermined area, such as a campus or building;

FIG. 2 is a representation of one exemplary flow diagram for providing monitoring according to one implementation of the present method; and

FIG. 3 is a representation of another exemplary flow diagram for providing monitoring according to another implementation of the present method.

### DETAILED DESCRIPTION

A methodology according to the present apparatus and method is to send a notification message to the law enforcement agents when the monitored phones enter certain pre-defined geo-locations identified as high security areas. The network further enables law enforcement agents to provision a list of phone numbers to be monitored and to provision a list of locations or buildings as high security areas. In cellular systems the geo-location of a mobile terminal is known as long as the mobile terminal is turned on, whether or not the mobile terminal is currently conducting a call. In the telecommunication system the geo-location may be a cell (macrocell or microcell) that is currently occupied by the mobile terminal.

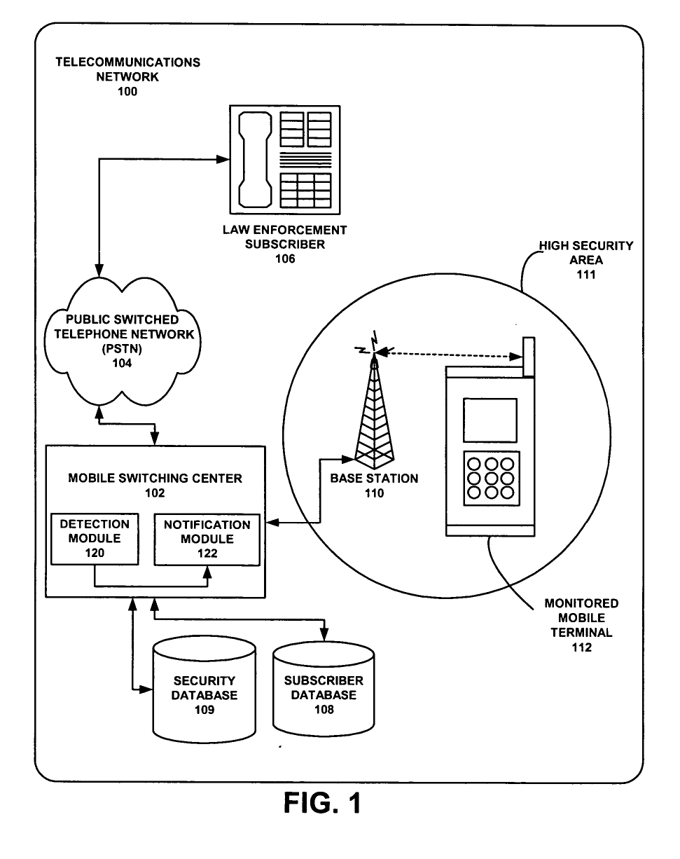

FIG. 1 is a representation of one implementation of an apparatus that provides a monitoring system to monitor the geo-locations of identified suspects and to send a notification message to, for example, law enforcement agents when the monitored mobile terminals enter certain pre-defined geo-locations identified as high security areas. It is to be noted that the present method and apparatus may be utilized by a variety of agencies or individuals and not just law enforcement agents.

A telecommunications network 100 may have a mobile switching center (MSC) 102. The network 100 may be, or may be part of, one or more of a telephone network, a local area network (“LAN”), the Internet, and a wireless network. In the depicted embodiment, a public switched telephone network (PSTN) 104 may be connected to the MSC 102. The PSTN 104 may, for example, route calls to and from a mobile terminal 112 through the MSC 102, and to a wireline terminal, such as law enforcement subscriber 106. The MSC 102 may also be connected to at least one base station (BS) 110. The base station 110 may communicate with the mobile terminal 112 in its service area (such as, high security area 111) using a subscriber database 108. The high security area 111 may, for example, be a macrocell or a microcell in the telecommunications network 100.

The PSTN 104 generally may be implemented as the worldwide voice telephone network accessible to all those with telephones and access privileges (e.g., AT&T long distance network). The MSC may also have a secure zone occupants database 109. The mobile terminal 112 may be any one of a number of devices, such as a cell phone, a personal data assistant (PDA), a laptop computer, etc.

As depicted in FIG. 1 the high security area 111 may correspond to any predetermined area, such as a building, a campus, an airport, etc. For very small high security areas, microcells may be used. Each of the high security areas has a corresponding geo-location.

The MSC 102 may be operatively coupled to a security database 109. The security database 109 may contain a list of high security areas and associated geo-locations, and a list of phone numbers, respectively corresponding to mobile terminals, for notification when at least one of mobile terminal enters one of the high security areas. The security database may also contain information relating an individual who has a particular mobile terminal that corresponds to one of the monitored phone numbers, such as, physical characteristics, known associates, vehicle owned, etc.

The MSC 102 may have a detection module 120, which outputs a signal when the mobile terminal 112, corresponding to a stored phone number, enters the high security area 111, the detection module 120 being operatively coupled to a notification module 122. The notification module 122 may output a notification message to the subscriber terminal 106 when the mobile terminal 112 enters the high security area 111. The notification module 122 may be operatively coupled to the security database 109, which in general may be referred to as a storage. The security database 109 may alternatively be located in the MSC 102, it may alternately be part of the subscriber database, or may be located at another location in the telecommunication network.

In one embodiment of the present method and apparatus, the system may be used by law enforcement agents to monitor locations for the presence of suspect individuals. Initially, a law enforcement agent may subscribe to this feature of the wireless telecommunication system. The subscriber then provisions a list of high security areas/buildings and their associated geo-locations. The subscriber also may provision a list of phone numbers that he/she would like to receive a notification message when a mobile terminal corresponding to one of the phone numbers approaches the defined high security areas.

The network starts monitoring the geo-location for each provisioned phone number periodically, i.e. every 5 minutes. When any monitored phone enters any of the defined high security areas, the network may send a notification message to the subscriber with the appropriate data including the monitored phone number, and the geo-location of the high security area.

For example, a monitored phone number may be entering O'Hare airport (which has been designated as a high security area), then the following information may be included in the notification message to be sent to the subscriber:

Monitored Number: 111-555-1212 Specified Party: xyz

Description of Suspect: 6′5″ male, 27 years old, brown hair, glasses

High Security Area: Chicago O'Hare airport

The law enforcement agent may then take appropriate actions if necessary.

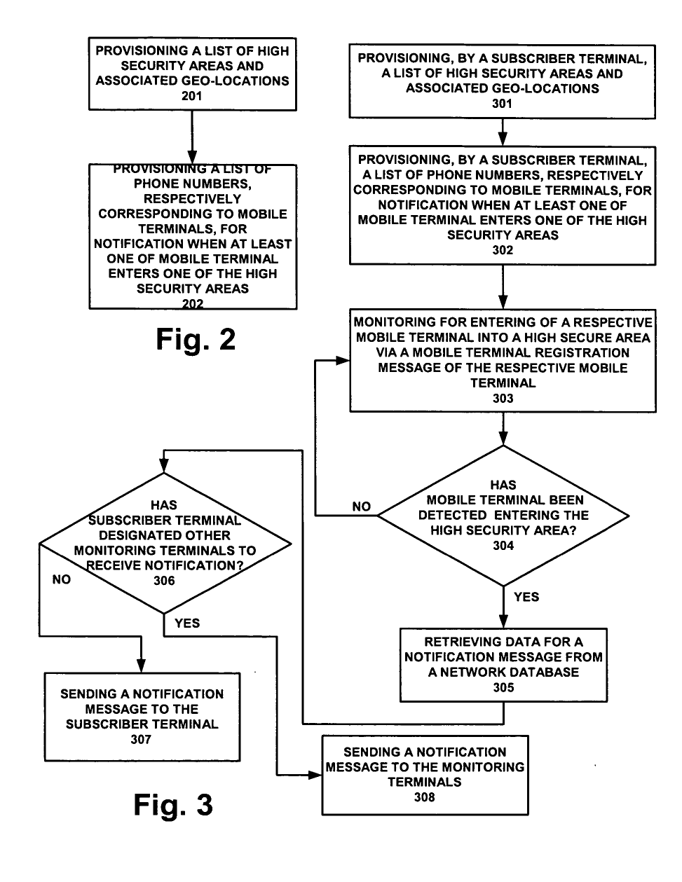

FIG. 2 is a representation of one exemplary flow diagram for a monitoring system that monitors the geo-locations of identified suspects. The method may have the steps of: provisioning a list of high security areas and associated geo-locations (201); and provisioning a list of phone numbers, respectively corresponding to mobile terminals, for notification when at least one of mobile terminal enters one of the high security areas (202).

FIG. 3 is a representation of one exemplary flow diagram for a monitoring system that monitors the geo-locations of identified suspects. This method may have the steps of: provisioning, by a subscriber terminal, a list of high security areas and associated geo-locations (301); provisioning, by a subscriber terminal, a list of phone numbers, respectively corresponding to mobile terminals, for notification when at least one of mobile terminal enters one of the high security areas (302); monitoring for entering of a respective mobile terminal into a high secure area via a mobile terminal registration message of the respective mobile terminal (303); has mobile terminal been detected entering the high security area? (304); retrieving data for a notification message from a network database (305); has subscriber terminal designated other monitoring terminals to receive notification? (306); sending a notification message to the subscriber terminal (307); and sending a notification message to the monitoring terminals (308).

Embodiments of the present apparatus and method overcomes the drawbacks of the prior art by implementing a trigger using the obtained mobile geo-location information to determine if a mobile terminal is entering a certain pre-defined high security area and by sending a notification message if the trigger fires.

The present apparatus in one example may comprise a plurality of components such as one or more of electronic components, hardware components, and computer software components. A number of such components may be combined or divided in the apparatus.

The present apparatus in one example may employ one or more computer-readable signal-bearing media. The computer-readable signal-bearing media may store software, firmware and/or assembly language for performing one or more portions of one or more embodiments. Examples of a computer-readable signal-bearing medium for the apparatus 100 may comprise the recordable data storage medium (subscriber database 108). The computer-readable signal-bearing medium for the apparatus 100 in one example may comprise one or more of a magnetic, electrical, optical, biological, and atomic data storage medium. For example, the computer-readable signal-bearing medium may comprise floppy disks, magnetic tapes, CD-ROMs, DVD-ROMs, hard disk drives, and electronic memory. In another example, the computer-readable signal-bearing medium may comprise a modulated carrier signal transmitted over a network comprising or coupled with the apparatus, for instance, one or more of a telephone network, a local area network (“LAN”), a wide area network (“WAN”), the Internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus, comprising:
at least one mobile terminal in a wireless telecommunications network;
at least one high security area in the wireless telecommunications network;
a storage in the wireless telecommunications network, the storage having at least one phone number corresponding to the at least one mobile terminal;
detection module in the wireless telecommunications network that outputs a signal when at least one mobile terminal, corresponding to the stored phone number, enters the at least one high security area, the detection module operatively coupled to the storage; and
notification module in the wireless telecommunications network that outputs a notification message when the at least one of the mobile terminal enters the at least one high security area, the notification module operatively coupled to the detection module.

2. The apparatus according to claim 1, wherein the wireless telecommunications network has a plurality of mobile terminals, a plurality of stored phone numbers, and a plurality of high security areas.

3. The apparatus according to in claim 1, wherein the apparatus further comprises subscriber terminal in the wireless network, the subscriber terminal receiving the notification message.

4. The apparatus according to claim 1, wherein high security areas are defined by at least one of a macrocell and a microcell in the wireless telecommunications network, and wherein the high security areas are respectively associated with geo-locations.

5. The apparatus according to claim 4, wherein the geo-locations are periodically monitored for the presence of mobile terminals corresponding to the stored phone numbers.

6. The apparatus according to claim 1, wherein an entering of a respective mobile terminal into a respective high secure area is detected via a mobile terminal registration message of the respective mobile terminal.

7. The apparatus according to claim 1, wherein the notification message includes at least a phone number of a respective mobile terminal entering a high secure area, and a geo-location of the entered high security area.

8. A method comprising:
implementing a trigger using obtained mobile geo-location information to determine if a mobile terminal is entering a predetermined high security area; and
sending a notification message if the trigger outputs a signal that the mobile terminal has entered the predetermined high security area.

9. The method according to claim 8, wherein the method further comprises:
provisioning a list of high security areas and associated geo-locations; and
provisioning a list of phone numbers, respectively corresponding to mobile terminals, for notification when at least one of mobile terminal enters one of the high security areas.

10. The method according to claim 9, wherein a high security area is defined by at least one microcell in a wireless telecommunications network, and wherein the list of phone numbers is stored in a storage in the network.

11. The method according to claim 8, wherein the trigger is a detecting of the entering of a respective mobile terminal into a high security area via a mobile terminal registration message of the respective mobile terminal.

12. The method according to claim 9, wherein the method further comprises periodically monitoring the geo-locations for each provisioned phone number.

13. The method according to claim 8, wherein the notification message includes at least phone number of a respective mobile terminal entering a high secure area, and an identification of the entered high security area.

14. A method, comprising:
provisioning a list of high security areas and associated geo-locations;
provisioning a list of phone numbers, respectively corresponding to mobile terminals, for notification when at least one of mobile terminal enters one of the high security areas; and
sending a notification message when at least one of mobile terminal enters one of the high security areas.

15. The method according to claim 14, wherein a high security area is defined by at least one microcell in a wireless telecommunications network, and wherein the list of phone numbers is stored in a storage in the wireless telecommunications network.

16. The method according to claim 14, wherein the method further comprises detecting the entering of a respective mobile terminal into a high security area via a mobile terminal registration message of the respective mobile terminal.

17. The method according to claim 14, wherein the method further comprises periodically monitoring the geo-locations for each provisioned phone number.

18. The method according to claim 14, wherein the notification message includes at least phone number of a respective mobile terminal entering a high secure area, and an identification of the entered high security area.

19. The method according to claim 14, wherein the method further comprises sending the notification message to at least one subscriber terminal in the telecommunications network.

20. The method according to claim 19, wherein the method further comprises sending the notification message to a plurality of monitoring terminals in the telecommunications network designated by the at least one subscriber terminal in the telecommunications network.
